(19) United States
(12) Patent Application Publication
(10) Pub. No.: US 2026/0336576 A1
(43) Pub. Date: Oct. 29, 2026

(54) BRAKE SYSTEM AND METHOD FOR CONTROLLING THE SAME

(71) Applicant: HL MANDO CORPORATION, Gyeonggi-do (KR)

(72) Inventors: Sihun LEE, Gyeonggi-do (KR); Jaehoon JANG, Gyeonggi-do (KR); Gyunghun SIM, Gyeonggi-do (KR); Yongkil KIM, Gyeonggi-do (KR)

(21) Appl. No.: 19/408,340

(22) Filed: Dec. 3, 2025

(30) Foreign Application Priority Data
Apr. 28, 2025 (KR) 10-2025-0055740

(51) Int. Cl. B60T 8/172; B60T 8/171; B60T 13/74; F16D 66/00; H02P 29/60

(52) U.S. Cl. CPC B60T 8/172; B60T 8/171; B60T 13/746; H02P 29/60; B60T 2220/04; B60T 2270/82; F16D 2066/001

(57) ABSTRACT

The brake system is provided. The brake system comprises a plurality of electro-mechanical brakes including motors installed on each wheel of a vehicle to generate braking force; and a controller that receives a signal output from a brake pedal sensor of the vehicle to determine target braking torque and applies motor applied current to the motor of each of the plurality of electro-mechanical brakes based on the target braking torque, wherein the controller reduces the motor applied current by a predetermined current reduction amount when the target braking torque is maintained for a preset time, and intermittently applies auxiliary current to the motor according to a preset cycle in a state where the motor applied current is reduced by the predetermined current reduction amount.

### CROSS REFERENCE TO PARENT APPLICATIONS

This application claims the benefit of Korean Patent Application Serial No. 10-2025-0055740 filed on Apr. 28, 2025, in the Korean Intellectual Property Office, the disclosure of which is incorporated herein by reference.

### BACKGROUND

Various embodiments of the present disclosure relate to a brake system and a method for controlling the same, and more particularly, to a brake system and its control method for controlling the vehicle's braking according to the hysteresis phenomenon that occurs during the operation of an electro-mechanical brake.

An Electro-Mechanical Brake (EMB) system is a technology that electrically controls a vehicle's braking system, generating braking force through mechanical components such as a permanent magnet synchronous motor (PMSM), gearbox, and belt. The electro-mechanical brake system generates clamping force through rotational force of the motor, and friction characteristics of the gearbox significantly affect the operation of the electro-mechanical brake.

The efficiency characteristics of the gear unit in brake systems are a core element of braking force control. Due to friction force of the gearbox, a certain level of clamping force can be maintained even after motor torque is released. However, this characteristic can simultaneously cause control difficulties. Due to the physical characteristic that kinetic friction force is smaller than static friction force, when current decreases below a specific threshold value, gears may unintentionally rotate in reverse direction, which can lead to braking force instability.

This gear disengagement phenomenon poses a direct threat to the stability and reliability of the braking system. When gears begin reverse rotation due to disengagement phenomenon, clamping force decreases rapidly, and to recover this, the motor must be rotated again in the forward direction. Additionally, since the threshold current value changes dynamically according to clamping force, monitoring and controlling this in real time is technically difficult to implement.

Conventionally, to prevent such gear disengagement phenomena, current reduction amounts were set to minimum levels to apply hysteresis control conservatively, or reactive methods of increasing current after gear reverse rotation occurred were used. However, such conventional approaches had limitations in that they could not fully utilize the energy efficiency that is the core advantage of hysteresis control, or could not completely resolve braking force instability due to gear reverse rotation. In particular, conventional methods were passive control approaches that responded after gear disengagement occurred, having fundamental limitations in securing braking stability.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, a brake system comprises: a plurality of electro-mechanical brakes including motors installed on each wheel of a vehicle to generate braking force; and a controller that receives a signal output from a brake pedal sensor of the vehicle to determine target braking torque and applies motor applied current to the motor of each of the plurality of electro-mechanical brakes based on the target braking torque, wherein the controller reduces the motor applied current by a predetermined current reduction amount when the target braking torque is maintained for a preset time, and intermittently applies auxiliary current to the motor according to a preset cycle in a state where the motor applied current is reduced by the predetermined current reduction amount.

The controller may include: a motor controller that applies the motor applied current to the motor based on the target braking torque and intermittently applies the auxiliary current to the motor according to the preset cycle; and a brake controller that transmits the target braking torque to the motor controller.

The brake controller may transmit a hysteresis control signal to the motor controller when the target braking torque is maintained for the preset time, and the motor controller may reduce the motor applied current by the predetermined current reduction amount upon receiving the hysteresis control signal.

The predetermined current reduction amount may be determined based on a predefined mapping table.

The predefined mapping table may be configured with correspondence relationships among the target braking torque, temperature of the motor, degree of brake pad wear, and current reduction amount for maintaining actual braking torque according to the target braking torque.

The controller may adjust the preset cycle when a change in at least one of motor position, gearbox rotation angle, the target braking torque, and actual braking torque is detected while intermittently applying the auxiliary current to the motor.

The controller may adjust the motor applied current based on the changed target braking torque when a change in the target braking torque is detected after reducing the motor applied current by the predetermined current reduction amount.

The controller may reduce the magnitude of the auxiliary current when no change is detected in at least one of motor position, gearbox rotation angle, the target braking torque, and actual braking torque while intermittently applying the auxiliary current to the motor.

The controller may determine the magnitude of the auxiliary current based on cogging torque of the motor and friction force of the gearbox.

The controller may adjust the preset cycle based on temperature of the motor.

According to some embodiments of the present disclosure, a control method of a brake system comprises: determining target braking torque based on a signal output from a brake pedal sensor of a vehicle; applying motor applied current to a motor based on the target braking torque; determining whether the target braking torque is maintained for a preset time; reducing the motor applied current by a predetermined current reduction amount when the target braking torque is maintained for the preset time; and intermittently applying auxiliary current to the motor according to a preset cycle in a state where the motor applied current is reduced by the predetermined current reduction amount.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 illustrates a configuration of a vehicle including a brake system according to one or more exemplary embodiments of the present disclosure.

FIG. 2 illustrates a configuration of a controller according to one or more exemplary embodiments of the present disclosure.

FIG. 3 is a graph showing actual clamping force and torque acting on a motor over time during a general hysteresis control process and a graph showing actual clamping force and torque acting on a motor over time during a hysteresis control process according to one or more exemplary embodiments of the present disclosure.

FIG. 4 illustrates a hysteresis control operation of a brake system according to one or more exemplary embodiments of the present disclosure.

FIG. 5 illustrates an operation of adjusting a preset cycle or motor applied current according to specific conditions while applying auxiliary current during a hysteresis control operation of a brake system according to one or more exemplary embodiments of the present disclosure.

FIG. 6 illustrates an operation of increasing or reducing the magnitude of auxiliary current according to specific conditions during a hysteresis control operation of a brake system according to one or more exemplary embodiments of the present disclosure.

FIG. 7 illustrates an operation of controlling a preset cycle according to motor temperature during a hysteresis control operation of a brake system according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

In the present disclosure, ‘hysteresis’ refers to a nonlinear relationship between clamping force and motor applied current in electro-mechanical brakes. Specifically, it refers to a phenomenon where clamping force does not immediately decrease for a certain period even when motor applied current is reduced. This occurs due to mechanical characteristics, friction characteristics, and elastic deformation of materials in the brake system.

Due to the hysteresis phenomenon, even when motor applied current is reduced to a certain level to maintain target braking force, actual clamping force is maintained almost unchanged. In the present disclosure, control that can reduce current (motor applied current) supplied to an actuator to a certain degree while maintaining braking force by utilizing characteristics of this hysteresis phenomenon is called ‘Hysteresis Control’.

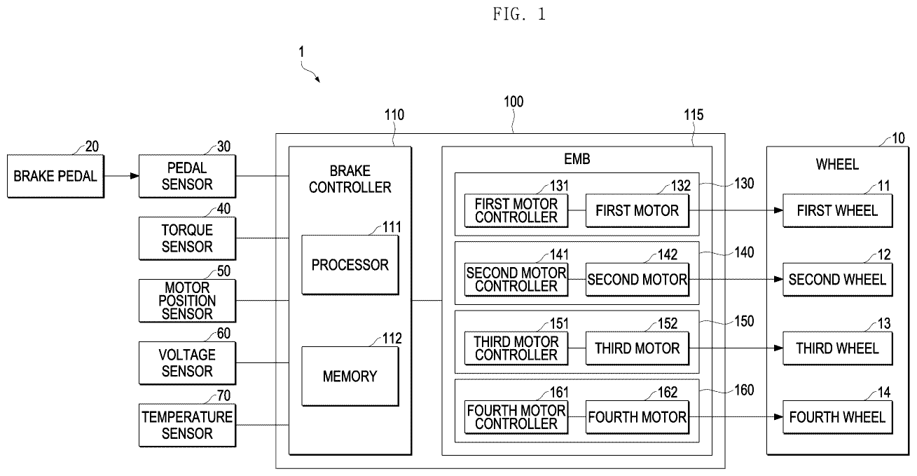

Referring to FIG. 1, the vehicle 1 may include wheels 10, a brake pedal 20, a pedal sensor 30, a torque sensor 40, a motor position sensor 50, a voltage sensor 60, a temperature sensor 70, a plurality of electro-mechanical brakes 130, 140, 150, 160 installed on each wheel 10, and/or a brake controller 110. Additionally, the vehicle 1 may further include sensors that detect movement (dynamics) of the vehicle 1. Although not shown, for example, the vehicle 1 may further include wheel speed sensors installed on each wheel 10, a vehicle speed sensor that detects longitudinal speed of the vehicle 1, an acceleration sensor that detects longitudinal acceleration and lateral acceleration of the vehicle 1, and/or a gyro sensor that detects yaw rate, roll rate, and pitch rate of the vehicle 1.

These components can communicate with each other through a vehicle communication network NT. For example, electrical devices included in the vehicle 1 can exchange data through Ethernet, MOST (Media Oriented Systems Transport), Flexray, CAN (Controller Area Network), LIN (Local Interconnect Network), etc.

The plurality of electro-mechanical brakes 130, 140, 150, 160 are installed on each wheel 10 to stop the vehicle 1, and may include, for example, brake calipers, motors 132, 142, 152, 162 that drive the brake calipers, and motor controllers 131, 141, 151, 161 that control the motors. The brake calipers operate by driving of the motors and can decelerate or stop the vehicle 1 using friction with brake discs.

The plurality of electro-mechanical brakes 130, 140, 150, 160 may further include torque sensors 40, motor position sensors 50, voltage sensors 60, and/or temperature sensors 70 installed on each wheel 10.

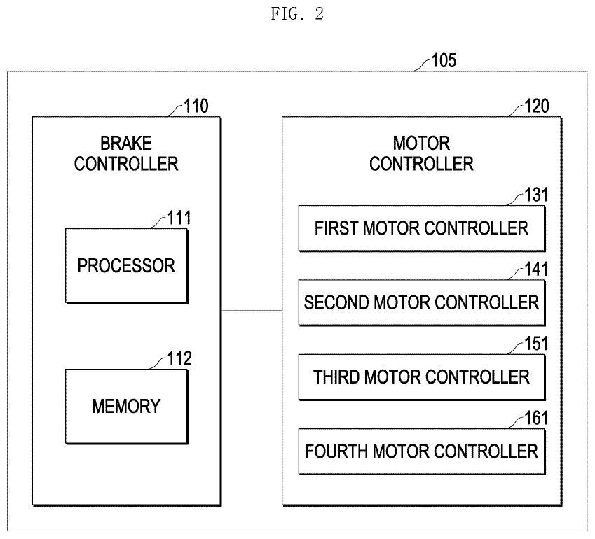

Referring to FIG. 2, the controller 105 may include a brake controller 110 and a motor controller 120.

The brake controller 110 may transmit target braking torque to the motor controller 120.

The motor controller 120 may apply motor applied current to the motors 132, 142, 152, 162 based on the target braking torque.

The controller 105 may receive a signal output from the brake pedal sensor 30 of the vehicle 1 to determine target braking torque and apply motor applied current to the motors 132, 142, 152, 162 based on the target braking torque.

The controller 105 may reduce the motor applied current by a predetermined current reduction amount when the target braking torque is maintained for a preset time. The predetermined current reduction amount may be determined based on a predefined mapping table.

The predefined mapping table may be configured with correspondence relationships among target braking torque, temperature of the motors 132, 142, 152, 162, degree of brake pad wear, and current reduction amount for maintaining actual braking torque according to the target braking torque.

The controller 105 may intermittently apply auxiliary current to the motors 132, 142, 152, 162 according to a preset cycle after reducing the motor applied current by the predetermined current reduction amount.

The controller 105 may adjust the preset cycle when a change in at least one of position of the motors 132, 142, 152, 162, rotation angle of the gearbox, target braking torque, and actual braking torque is detected while intermittently applying auxiliary current to the motors 132, 142, 152, 162 according to the preset cycle.

Alternatively, the controller 105 may adjust the preset cycle based on temperature of the motors 132, 142, 152, 162 while intermittently applying auxiliary current to the motors 132, 142, 152, 162 according to the preset cycle. For example, the controller 105 may increase the preset cycle when temperature of the motors 132, 142, 152, 162 exceeds a threshold temperature.

The controller 105 may reduce the magnitude of auxiliary current when no change is detected in at least one of position of the motors 132, 142, 152, 162, rotation angle of the gearbox, target braking torque, and actual braking torque while intermittently applying auxiliary current to the motors 132, 142, 152, 162 according to the preset cycle.

The controller 105 may increase the magnitude of auxiliary current when a change in at least one of position of the motors 132, 142, 152, 162, rotation angle of the gearbox, target braking torque, and actual braking torque is detected after reducing the magnitude of auxiliary current.

The controller 105 may determine the magnitude of auxiliary current based on cogging torque of the motors 132, 142, 152, 162 and friction force of the gearbox.

The controller 105 may increase motor applied current when a change in at least one of position of the motors 132, 142, 152, 162, position of brake pads, and actual braking torque is detected after reducing the motor applied current by the predetermined current reduction amount.

The controller 105 may increase or reduce motor applied current based on the changed target braking torque when a change in target braking torque is detected after reducing the motor applied current by the predetermined current reduction amount.

The controller 105 may update the predefined mapping table with a current reduction amount at a time point a certain time before the time point when change is detected as the predetermined current reduction amount when a change in at least one of position of the motors 132, 142, 152, 162, position of brake pads, and actual braking torque is detected while reducing motor applied current by the predetermined current reduction amount.

The controller 105 may increase the predetermined current reduction amount when no change is detected in at least one of position of the motors 132, 142, 152, 162, position of brake pads, and actual braking torque after reducing motor applied current by the predetermined current reduction amount. That is, the controller 105 may further reduce motor applied current. The controller 105 may update the predefined mapping table with a current reduction amount at a time point a certain time before the time point when change is detected as the predetermined current reduction amount when a change in at least one of position of the motors 132, 142, 152, 162, position of brake pads, and actual braking torque is detected while motor applied current is further reduced in response to increasing the predetermined current reduction amount.

For the controller 105 to perform the aforementioned hysteresis control, the brake controller 110 and motor controller 120 included in the controller 105 are configured to perform cooperative control, which will be described as follows.

Referring again to FIG. 1, the motor controllers 131, 141, 151, 161 may respectively receive and process signals output from the torque sensor 40, motor position sensor 50, voltage sensor 60, and/or temperature sensor 70. Accordingly, the motor controllers 131, 141, 151, 161 may respectively monitor actual braking torque, motor position, voltage supplied to the motors 132, 142, 152, 162, and temperature of the motors 132, 142, 152, 162 of the corresponding electro-mechanical brakes 130, 140, 150, 160.

The motor controllers 131, 141, 151, 161 may receive target braking torque from the brake controller 110 to apply current to the motors 132, 142, 152, 162 to generate the target braking torque, and may intermittently apply auxiliary current to the motors 132, 142, 152, 162 according to a preset cycle.

The motor controllers 131, 141, 151, 161 may identify activation of hysteresis control signal by receiving the hysteresis control signal from the brake controller 110. Additionally, the motor controllers 131, 141, 151, 161 may identify deactivation of hysteresis control signal by receiving a hysteresis control termination signal from the brake controller 110.

The motor controllers 131, 141, 151, 161 may reduce motor applied current by a predetermined current reduction amount when the hysteresis control signal is activated. That is, the motor controllers 131, 141, 151, 161 may reduce the motor current by the predetermined current reduction amount when the hysteresis control signal is activated.

At this time, the motor controllers 131, 141, 151, 161 may determine the predetermined current reduction amount based on a predefined mapping table.

Here, the predefined mapping table may be configured with correspondence relationships among target braking torque, temperature of the motors 132, 142, 152, 162, degree of brake pad wear, and current reduction amount for maintaining actual braking torque according to the target braking torque. For example, specific target braking torque, degree of brake pad wear, and temperature of the motors 132, 142, 152, 162 may be given as a kind of parameter pair, and accordingly, current reduction amount for maintaining actual braking torque according to the target braking torque may be predetermined.

The current reduction amount may initially be a predetermined value. For example, initially the predetermined current reduction amount may be a value corresponding to about 7% to 8% of motor applied current. The initially predetermined current reduction amount may later be changed or updated to other values.

The brake controller 110 may be connected to the pedal sensor 30, torque sensors 40 installed on each wheel 10, motor position sensors 50, voltage sensors 60, temperature sensors 70, and/or motor controllers 131, 141, 151, 161 through the vehicle communication network NT.

The brake controller 110 may receive and process output signals from the pedal sensor 30 and torque sensors 40, motor position sensors 50, voltage sensors 60, and temperature sensors 70 installed on each wheel 10.

The brake controller 110 may determine target braking torque required for deceleration based on output signals from the pedal sensor 30 corresponding to the driver's braking intention, and transmit the determined target braking torque to the plurality of electro-mechanical brakes 130, 140, 150, 160. The brake controller 110 may determine target braking torque required for deceleration based further on output signals from wheel speed sensors (not shown).

The brake controller 110 activates hysteresis control signal when target braking torque is maintained for a preset time. This may be implemented by the brake controller 110 transmitting hysteresis control signal to the motor controllers 131, 141, 151, 161.

The brake controller 110 may deactivate hysteresis control signal in response to position change of the motors 132, 142, 152, 162. The brake controller 110 may deactivate hysteresis control signal in response to position change of brake pads. The brake controller 110 may deactivate hysteresis control signal in response to change in actual braking torque. The brake controller 110 may deactivate hysteresis control signal in response to change in target braking torque. Deactivating hysteresis control signal may be implemented by the brake controller 110 transmitting a hysteresis control termination signal to the motor controllers 131, 141, 151, 161.

The brake controller 110 may include a processor 111 and a memory 112.

The memory 112 may store programs and/or data for processing output signals from the pedal sensor 30 and torque sensors 40, motor position sensors 50, voltage sensors 60, and temperature sensors 70 installed on each wheel 10, and output signals from wheel speed sensors (not shown).

Additionally, the memory 112 may store programs and/or data for generating braking torque and/or target braking torque and/or auxiliary torque.

Additionally, the memory 112 may store predefined mapping tables for each of the plurality of electro-mechanical brakes 130, 140, 150, 160 for hysteresis control.

The memory 112 may include volatile memory such as S-RAM and D-RAM as well as non-volatile memory such as flash memory, Read Only Memory (ROM), and Erasable Programmable Read Only Memory (EPROM).

The processor 111 may process output signals from the pedal sensor 30, output signals from the pedal sensor 30 and torque sensors 40, motor position sensors 50, voltage sensors 60, and temperature sensors 70 installed on each wheel 10, and output signals from wheel speed sensors (not shown).

The processor 111 may generate target braking torque based on output signals from the pedal sensor 30 (and/or output signals from wheel speed sensors) and transmit the determined target braking torque to the plurality of electro-mechanical brakes 130, 140, 150, 160.

The processor 111 may activate hysteresis control signal when target braking torque is maintained for a preset time. Activating hysteresis control signal may be implemented by the processor 111 transmitting hysteresis control signal to the motor controllers 131, 141, 151, 161.

The processor 111 may deactivate hysteresis control signal in response to position change of the motors 132, 142, 152, 162. The processor 111 may deactivate hysteresis control signal in response to position change of brake pads. The processor 111 may deactivate hysteresis control signal in response to change in actual braking torque. The processor 111 may deactivate hysteresis control signal in response to change in target braking torque. Deactivating hysteresis control signal may be implemented by the processor 111 transmitting a hysteresis control termination signal to the motor controllers 131, 141, 151, 161.

The processor 111 may include a Micro Control Unit (MCU) that processes output signals from the pedal sensor 30 and torque sensors 40, motor position sensors 50, voltage sensors 60, and temperature sensors 70 installed on each wheel 10, output signals from wheel speed sensors (not shown), and determines target braking torque and actual braking torque.

The brake controller 110 may determine target braking torque based on signals output from the pedal sensor 30 and transmit the determined target braking torque to the electro-mechanical brakes 130, 140, 150, 160.

The brake controller 110 may determine whether there is a change in target braking torque based on signals output from the pedal sensor 30. The brake controller 110 may activate hysteresis control signal by transmitting hysteresis control signal to the electro-mechanical brakes 130, 140, 150, 160 when target braking torque is maintained for a predetermined time.

Additionally, the brake controller 110 continues to determine whether there is a change in target braking torque based on signals output from the pedal sensor 30 even after the hysteresis control signal is activated. If there is a change in target braking torque, the brake controller 110 may deactivate hysteresis control signal by transmitting a hysteresis control termination signal to the electro-mechanical brakes 130, 140, 150, 160.

The brake controller 110 determines whether there are changes in actual braking torque, position of the motors 132, 142, 152, 162, and position of brake pads based on output signals from torque sensors 40, motor position sensors 50, voltage sensors 60, and temperature sensors 70 installed on each wheel 10. If there is a change in actual braking torque, or position change of the motors 132, 142, 152, 162, or position change of brake pads, the brake controller 110 may deactivate hysteresis control signal by transmitting a hysteresis control termination signal to the electro-mechanical brakes 130, 140, 150, 160.

Cases where current reduction amount is changed or updated can be broadly divided into two types.

First, when there is a change in either degree of brake pad wear or temperature of the motors 132, 142, 152, 162. In such cases, the current reduction amount corresponding to the target braking torque may be updated to a new current reduction amount.

For example, as hysteresis control signal is activated, a change in actual braking torque may occur while the motor controllers 131, 141, 151, 161 reduce motor applied current by a current reduction amount corresponding to specific target braking torque. That is, when position of the motors 132, 142, 152, 162 changes, position of brake pads changes, or actual braking torque detected by the torque sensor 40 changes. When a change in actual braking torque occurs before the motor controllers 131, 141, 151, 161 reduce motor applied current by a current reduction amount corresponding to specific target braking torque, this means a situation where hysteresis control is impossible. This also means a state where actual braking torque can no longer follow the target braking torque when motor applied current is reduced by the existing current reduction amount due to phenomena such as significant increase in degree of brake pad wear.

In other words, it means a situation where actual braking force weakens despite the fact that actual braking force should be maintained without change even when motor applied current is reduced by the existing current reduction amount. Therefore, in this case, the motor controllers 131, 141, 151, 161 must update the current reduction amount to a value smaller than the existing current reduction amount.

Another case where current reduction amount corresponding to target braking torque needs to be updated is when the motor controllers 131, 141, 151, 161 increase the predetermined current reduction amount if hysteresis control signal is not deactivated even after reducing motor applied current by the predetermined current reduction amount as hysteresis control signal is activated. When hysteresis control signal is not deactivated, it means that actual braking force is maintained even when motor applied current is reduced by the predetermined current reduction amount. At this time, the motor controllers 131, 141, 151, 161 may increase the predetermined current reduction amount.

For example, after the motor controllers 131, 141, 151, 161 reduce motor applied current by the predetermined current reduction amount, they may increase the predetermined current reduction amount by a certain amount in a state where hysteresis control signal is not deactivated. For example, if the predetermined current reduction amount is 0.7 A, the motor controllers 131, 141, 151, 161 reduce the existing motor applied current of 10.2 A to 9.5 A. Subsequently, if hysteresis control signal is not deactivated, the motor controllers 131, 141, 151, 161 may reduce motor applied current by a certain amount, for example, in units of 0.2 A. Therefore, motor applied current is reduced from 10.2 A before performing hysteresis control to 9.5 A when hysteresis control is performed with recovery of predetermined current reduction amount of 0.7 A, and is further reduced by 0.2 A to 9.3 A when a certain time passes in a state where hysteresis control signal is not deactivated. In this state, if hysteresis control signal is not deactivated and another certain time passes, motor applied current is further reduced by 0.2 A to 9.1 A. If hysteresis control signal is deactivated in this state, the predetermined current reduction amount becomes 0.9 A or 1.1 A as a new current reduction amount from the existing 0.7 A.

Cases where hysteresis control signal is deactivated are divided into two types.

First, when there is a change in target braking torque. For example, when pedal input applied to the brake pedal 20 is not maintained and becomes stronger or weaker.

Second, when target braking torque is maintained but there is a change in actual braking torque. That is, when position of the motors 132, 142, 152, 162 changes, position of brake pads changes, or actual braking torque detected by the torque sensor 40 changes.

When hysteresis control signal is deactivated due to change in target braking torque, current reduction amount should not be changed or updated.

To this end, the motor controllers 131, 141, 151, 161 may be configured not to change or update current reduction amount when they identify deactivation of hysteresis control signal but it is due to change in target braking torque.

To this end, the brake controller 110 may transmit a first hysteresis control termination signal to the motor controllers 131, 141, 151, 161 when change in target braking torque occurs. Additionally, the brake controller 110 may transmit a second hysteresis control termination signal to the motor controllers 131, 141, 151, 161 when change in actual braking torque occurs.

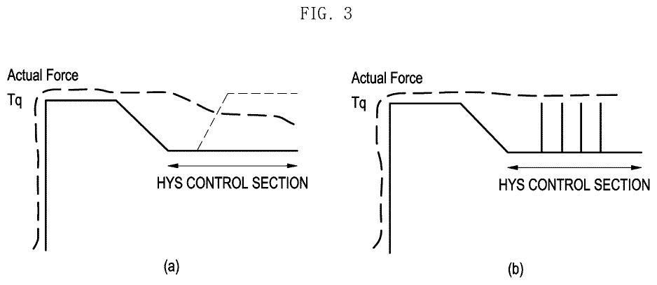

Referring to FIG. 3a, during general hysteresis control, when entering a hysteresis control section, actual clamping force weakens, requiring motor applied current to be increased again.

Referring to FIG. 3b showing a hysteresis control process according to an embodiment of the present invention, it can be confirmed that actual clamping force is stably maintained by intermittently applying auxiliary current to the motors 132, 142, 152, 162 according to a preset cycle when entering the hysteresis control section.

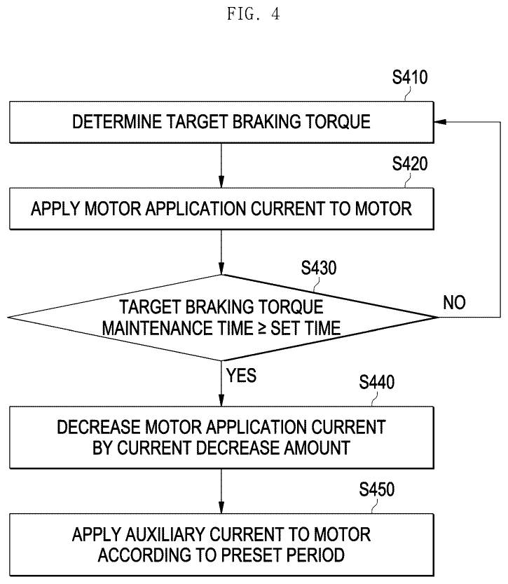

Referring to FIG. 4, the control operation of the brake system 100 may include determining target braking torque based on signals output from the brake pedal sensor 30 of the vehicle 1 (S410), applying motor applied current to the motors 132, 142, 152, 162 based on the target braking torque (S420), determining whether target braking torque is maintained for a preset time (S430), reducing motor applied current by a predetermined current reduction amount when target braking torque is maintained for the preset time (S440), and intermittently applying auxiliary current to the motors 132, 142, 152, 162 according to a preset cycle in a state where motor applied current is reduced by the predetermined current reduction amount (S450). Here, the predetermined current reduction amount may be determined based on a predefined mapping table. The predefined mapping table may be configured with correspondence relationships among target braking torque, temperature of the motors 132, 142, 152, 162, degree of brake pad wear, and current reduction amount for maintaining actual braking torque according to the target braking torque.

According to an embodiment, intermittently applying auxiliary current to the motors 132, 142, 152, 162 according to the preset cycle (S450) may further include determining the magnitude of auxiliary current based on cogging torque of the motors 132, 142, 152, 162 and friction force of the gearbox (not shown).

According to an embodiment, intermittently applying auxiliary current to the motors 132, 142, 152, 162 according to the preset cycle (S450) may further include increasing the magnitude of auxiliary current based on detecting reverse rotation of the motors 132, 142, 152, 162 (not shown).

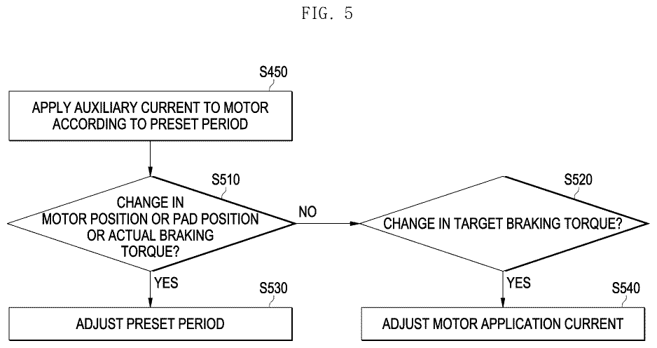

Referring to FIG. 5, it includes intermittently applying auxiliary current to the motors 132, 142, 152, 162 according to a preset cycle (S450), and adjusting the preset cycle (S530) when a change in at least one of position of the motors 132, 142, 152, 162, rotation angle of the gearbox, target braking torque, and actual braking torque is detected (Yes in S510). Meanwhile, when no change is detected in at least one of position of the motors 132, 142, 152, 162, rotation angle of the gearbox, target braking torque, and actual braking torque (No in S510), it further includes determining whether there is a change in target braking torque (S520), and adjusting motor applied current based on the changed target braking torque when a change in target braking torque is detected (S540).

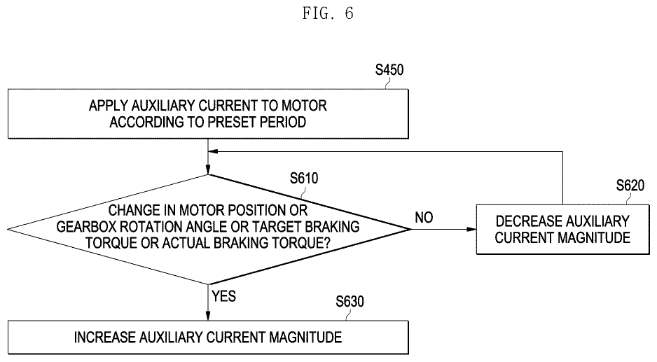

Referring to FIG. 6, it includes intermittently applying auxiliary current to the motors 132, 142, 152, 162 according to a preset cycle (S450), reducing the magnitude of auxiliary current when no change is detected in at least one of position of the motors 132, 142, 152, 162, rotation angle of the gearbox, target braking torque, and actual braking torque (S620 when No in S610), and increasing the magnitude of auxiliary current when a change is detected in at least one of position of the motors 132, 142, 152, 162, rotation angle of the gearbox, target braking torque, and actual braking torque (S630 when Yes in S610).

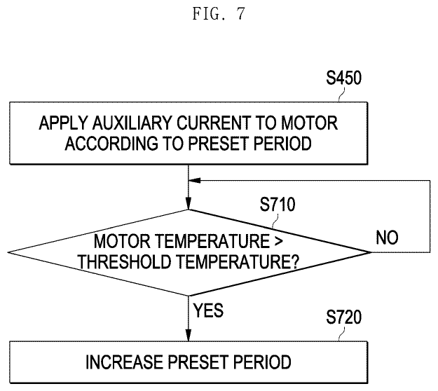

Referring to FIG. 7, it may include intermittently applying auxiliary current to the motors 132, 142, 152, 162 according to a preset cycle (S450), and increasing the preset cycle when temperature of the motors 132, 142, 152, 162 exceeds a threshold temperature (S720 when Yes in S710).

As described above, the brake system 100 according to an embodiment of the present invention can prevent motor reverse rotation phenomenon due to gear disengagement and enhance braking stability by intermittently applying auxiliary current to the motors 132, 142, 152, 162 according to a preset cycle when performing hysteresis control that reduces motor applied current below the existing level according to hysteresis phenomena.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A brake system comprising:
a plurality of electro-mechanical brakes including motors installed on each wheel of a vehicle to generate braking force; and
a controller that receives a signal output from a brake pedal sensor of the vehicle to determine target braking torque and applies motor applied current to the motor of each of the plurality of electro-mechanical brakes based on the target braking torque,
wherein the controller reduces the motor applied current by a predetermined current reduction amount when the target braking torque is maintained for a preset time, and intermittently applies auxiliary current to the motor according to a preset cycle in a state where the motor applied current is reduced by the predetermined current reduction amount.

2. The brake system of claim 1, wherein the controller comprises:
a motor controller that applies the motor applied current to the motor based on the target braking torque and intermittently applies the auxiliary current to the motor according to the preset cycle; and
a brake controller that transmits the target braking torque to the motor controller.

3. The brake system of claim 2, wherein the brake controller transmits a hysteresis control signal to the motor controller when the target braking torque is maintained for the preset time, and
the motor controller reduces the motor applied current by the predetermined current reduction amount upon receiving the hysteresis control signal.

4. The brake system of claim 1, wherein the predetermined current reduction amount is determined based on a predefined mapping table.

5. The brake system of claim 4, wherein the predefined mapping table is configured with correspondence relationships among the target braking torque, temperature of the motor, degree of brake pad wear, and current reduction amount for maintaining actual braking torque according to the target braking torque.

6. The brake system of claim 1, wherein the controller adjusts the preset cycle when a change in at least one of motor position, gearbox rotation angle, the target braking torque, and actual braking torque is detected while intermittently applying the auxiliary current to the motor.

7. The brake system of claim 1, wherein the controller adjusts the motor applied current based on the changed target braking torque when a change in the target braking torque is detected after reducing the motor applied current by the predetermined current reduction amount.

8. The brake system of claim 1, wherein the controller reduces magnitude of the auxiliary current when no change is detected in at least one of motor position, gearbox rotation angle, the target braking torque, and actual braking torque while intermittently applying the auxiliary current to the motor.

9. The brake system of claim 1, wherein the controller determines magnitude of the auxiliary current based on cogging torque of the motor and friction force of a gearbox.

10. The brake system of claim 1, wherein the controller adjusts the preset cycle based on temperature of the motor.

11. A control method of a brake system comprising:
determining target braking torque based on a signal output from a brake pedal sensor of a vehicle;
applying motor applied current to a motor based on the target braking torque;
determining whether the target braking torque is maintained for a preset time;
reducing the motor applied current by a predetermined current reduction amount when the target braking torque is maintained for the preset time; and
intermittently applying auxiliary current to the motor according to a preset cycle in a state where the motor applied current is reduced by the predetermined current reduction amount.

12. The control method of the brake system of claim 11, wherein the predetermined current reduction amount is determined based on a predefined mapping table.

13. The control method of the brake system of claim 12, wherein the predefined mapping table is configured with correspondence relationships among the target braking torque, temperature of the motor, degree of brake pad wear, and current reduction amount for maintaining actual braking torque according to the target braking torque.

14. The control method of the brake system of claim 11, further comprising adjusting the preset cycle when a change in at least one of motor position, gearbox rotation angle, the target braking torque, and actual braking torque is detected while intermittently applying the auxiliary current to the motor.

15. The control method of the brake system of claim 11, further comprising adjusting the motor applied current based on the changed target braking torque when a change in the target braking torque is detected after reducing the motor applied current by the predetermined current reduction amount.

16. The control method of the brake system of claim 11, further comprising reducing magnitude of the auxiliary current when no change is detected in at least one of motor position, gearbox rotation angle, the target braking torque, and actual braking torque while intermittently applying the auxiliary current to the motor.

17. The control method of the brake system of claim 11, further comprising increasing the magnitude of the auxiliary current when a change in at least one of the motor position, the gearbox rotation angle, the target braking torque, and the actual braking torque is detected after reducing the magnitude of the auxiliary current.

18. The control method of the brake system of claim 11, wherein intermittently applying the auxiliary current to the motor according to the preset cycle further comprises increasing magnitude of the auxiliary current based on detecting reverse rotation of the motor.

19. The control method of the brake system of claim 11, wherein intermittently applying the auxiliary current to the motor according to the preset cycle further comprises determining magnitude of the auxiliary current based on cogging torque of the motor and friction force of a gearbox.

20. The control method of the brake system of claim 11, further comprising increasing the preset cycle when temperature of the motor exceeds a threshold temperature.
